(19) United States
(12) Patent Application Publication
(10) Pub. No.: US 2012/0073174 A1
(43) Pub. Date: Mar. 29, 2012

(54) LABEL HOLDER

(76) Inventors: Gregory M. Bird, Solon, OH (US); Joseph P. Kosir, Euclid, OH (US)

(21) Appl. No.: 13/198,190

(22) Filed: Aug. 4, 2011

Related U.S. Application Data
(60) Provisional application No. 61/387,085, filed on Sep. 28, 2010.

(51) Int. Cl. G09F 3/18

(52) U.S. Cl. 40/661

(57) ABSTRACT

A single panel label holder for a product display supports a label for display to shoppers. The single panel traps the label against an adjacent surface of a corresponding shelf. The label holder can include a clip member for securing the label holder to the shelf.

### BACKGROUND

The present disclosure pertains to label holders for displaying information-containing labels or signs and, more particularly, holders which are cost effective and convenient to manufacture.

Clip-on label holders are known in the art. The general principle by which label holders are attached to an associated merchandise display shelf involves clipping and engaging the label holder around the forward end of the display shelf. The clipping motion involves the deflection of an elastic yet resilient material. During installation, the material of the label holder elastically deforms to allow engagement of the label holder with the shelf. Subsequently, the material relaxes and contacts the shelf in multiple locations. The degree and security of attachment depends on the amount of pressure exerted by the material of the label holder against the corresponding portion of the shelf.

Various clip-on label holders are currently on the market for displaying labels to a consumer. Typical label holders commonly include a main body or backing panel and a hingedly attached transparent cover. These together define a pocket between them for receipt of a non-adhesive label. A clip portion of the label holder attaches to a lip or other surface of the shelf such that the pocket is positioned on a front face of the shelf. While such label holders are sufficient for many applications, the provision of a pocket for receiving the label requires two opposing panels (the main body and the transparent cover) which can complicate manufacturing and uses more material, thus increasing costs and weight. It would be advantageous to provide a label holder which uses less material and is consequently less expensive as well as weighing less.

### BRIEF SUMMARY OF THE DISCLOSURE

A label holder according to the present disclosure supports a label for display with single panel by trapping the label against a surface of a corresponding shelf, thus significantly reducing the amount of material needed for the label holder as compared to prior art label holders which include a pocket for receiving the label. The label holder can thus be simpler to manufacture and will likely cost less to produce than prior art label holders.

According to one embodiment of the present disclosure, a retail display assembly comprises a shelf having a top panel, a front panel extending from the top panel, and a return flange extending from the front panel, and a label holder. The label holder includes a cover panel having a front surface, a back surface, an upper end and a lower end, a clip member extending rearwardly away from the cover panel, and a hinge connecting the lower end of the cover panel to the clip member. The label holder is selectively mountable to the shelf via the clip member. When mounted to the shelf, the back surface of the cover panel and the front surface of the shelf are configured to trap an associated item therebetween.

The associated item can include a label trapped between the back surface of the cover panel and the front surface of the shelf. At least a portion of the cover panel can be transparent for viewing the associated item. The cover portion can be moveable between a first position wherein the back surface is engaged with the front surface of the shelf, to a second position wherein the back surface is spaced apart from the front surface of the shelf. A distal edge of the cover portion opposite the hinge can include a bead for grasping by a user when moving the cover portion between the first and second positions. The hinge can be adapted to bias the cover portion towards the front surface of the shelf. The cover panel can be adapted to engage the front surface of the shelf along a major portion of a length of the cover panel extending between the upper and lower ends thereof. The clip member can include a pair of opposing jaws opening towards the hinge and configured to engage opposing sides of the return flange, the opposing jaws being biased towards each other to secure the label holder to the shelf.

According to another aspect of the present disclosure, a label holder comprises a cover panel having a front surface, a back surface, an upper end and a lower end, a clip member extending rearwardly away from the cover panel near the lower end thereof, and a hinge connecting the lower end of the cover panel to the clip member. The label holder can be selectively mounted to an associated shelf via the clip member for trapping an associated label between the rear surface of the cover panel and a corresponding surface of the associated shelf.

A portion of the cover panel can be transparent for viewing the associated label therethrough. The cover panel can be moveable between a first position for holding an associated label, and a second position for loading an associated label. The cover panel can be resiliently biased towards the first position. A distal edge of the cover panel opposite the hinge can include a bead for grasping by a user when moving the cover portion between the first and second positions. The hinge can be adapted to bias the cover portion towards a front surface of shelf when installed thereon. The clip member can include a pair of opposing jaws opening towards the hinge and configured to engage opposing sides of a flange of the associated shelf, the opposing jaws being biased towards each other to secure the label holder to the associated shelf. The cover panel can be resiliently biased towards the first position. The hinge can be adapted to bias the cover portion towards a front surface of shelf when installed thereon. A thickness of the cover panel can be less than a thickness of the clip portion. The thickness of the cover panel can be generally constant from the upper end to the lower end.

Other features and advantages of the present disclosure will become apparent from the following more detailed description, taken in conjunction with the accompanying drawings which illustrate by way of example several embodiments of the presently described apparatus and its method of use.

### BRIEF DESCRIPTION OF THE DRAWINGS

The disclosure may take form in certain structures and components, several embodiments of which will be described in detail in this specification and illustrated in the accompanying drawings.

FIG. 1 is an end elevational view of an exemplary display assembly including a label holder in accordance with the present disclosure;

FIG. 2 is an enlarged end elevational view of the label holder of FIG. 1;

FIG. 3 is an end elevational view of another exemplary label holder in accordance with the present disclosure.

### DETAILED DESCRIPTION

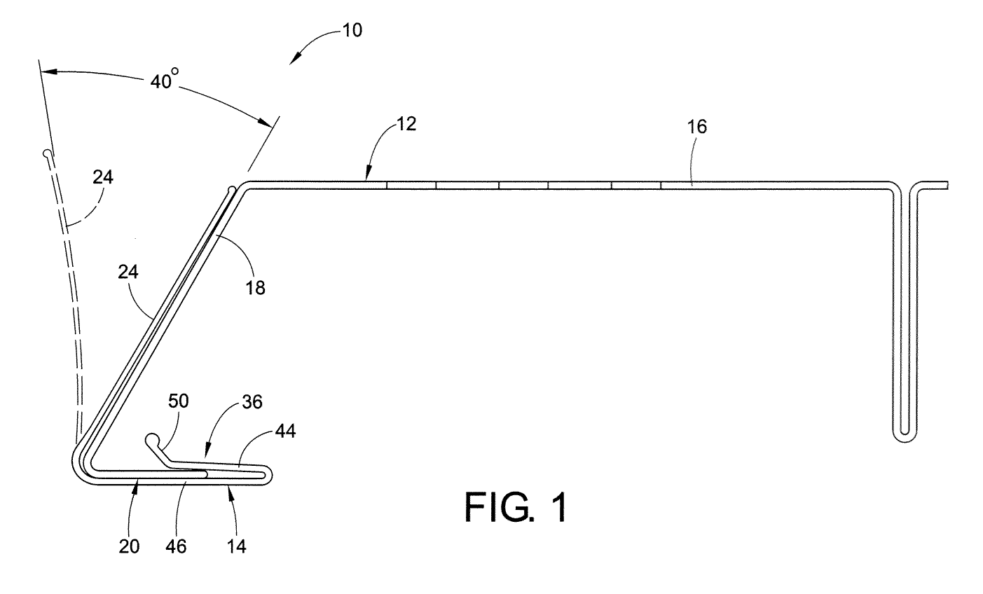

Referring now to the drawings, wherein the showings illustrate exemplary embodiments of the disclosure only and are not intended to limit same, FIG. 1 shows an exemplary retail display assembly in accordance with the present disclosure and identified generally by reference numeral 10. The retail display assembly 10 generally comprises a shelf 12 and a label holder 14 attached thereto. The shelf 12 generally includes a top panel 16, a front panel 18 extending from the top panel 16 and a return flange 20 extending from the front panel 18. The shelf 12 is exemplary in nature and it will be appreciated that a wide variety of shelf designs and configurations can be used in accordance with the present disclosure. The illustrated exemplary shelf 12 has a generally sloped front panel 18 extending in an angle downwardly from the top panel 16, and the return flange 20 extends rearwardly from the front panel 18 in a direction generally parallel to the top panel 16. Such a shelf 12 is sometimes referred to as a no-tag shelf. Such no-tag shelves generally do not include a channel on the front face for display of pricing information or other product related information. Thus, the label holder 14 is provided for supporting a label adjacent the front panel 18 of the shelf 12 for displaying information to a consumer.

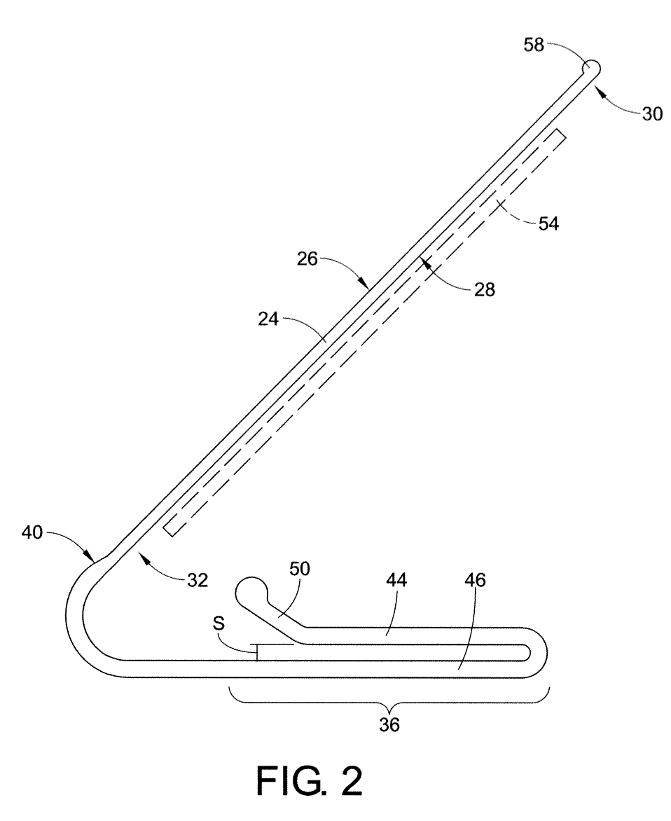

With further reference to FIG. 2, the label holder 14 generally includes a cover panel 24 having a front surface 26, a back or rear surface 28, an upper end 30 and a lower end 32. The label holder 14 includes a clip member portion 36 extending rearwardly away from the back surface 28 of the cover panel 24, and a hinge 40 connecting lower end 32 of the cover panel 24 to the clip member portion 36. As will be appreciated, the cross-sectional profile of the label holder 14 in the illustrated exemplary embodiment is similar to the cross-sectional profile of the front panel 18 of the shelf 12 and return flange 20 of the shelf 12. In this regard, when installed on the shelf 12, the cover panel 24 of the label holder 14 is configured to closely engage the front panel 18 of the shelf 12 such that a label containing product information can be trapped between the back surface 28 of the cover panel 24 and the front panel 18 of the shelf 12.

To secure the label holder 14 to the shelf 12, the clip member portion 36 includes a pair of opposing spaced-apart jaws, upper jaw 44 and lower jaw 46, that cooperate to engage opposite surfaces of the return flange 20 of the shelf 12 as seen in FIG. 1. The space S between the upper and lower jaws 44 and 46 generally will be less than a thickness of the return flange 20 such that when the return flange 20 is received between the jaws, the upper and lower jaws 44 and 46 are urged away from each other. Depending on the material and the amount the jaws are spread apart, the jaws may compressively engage the opposing sided of the return flange 20.

In order to ease installation of the clip member portion 36 on the return flange 20, a leading portion 50 of the upper jaw 44 is angled upwardly to thereby create a larger opening between the upper jaw 44 and the opposing lower jaw 46 at the opening of the clip member portion 36. This allows for greater tolerance in the alignment between the return flange 20 and the upper and lower jaws 44 and 46 during installation.

Returning to FIG. 1, when the label holder 14 is secured on the shelf 12 by the clip member portion 36, the cover panel 24 is movable between a first position wherein the back surface 28 of the cover panel 24 is engaged with the front panel 24 of the shelf 12, to a second position wherein the back surface 28 is spaced apart from the front panel 24 of the shelf 12 (shown in phantom in FIG. 1) such that a label 54 (FIG. 2) can be placed in the space between the cover panel 24 and the front panel 18 of the shelf 12. In this regard, the cover panel 24 is pivotable about the hinge 40 located between its lower end 32 and the clip member portion 36. The hinge 40 can be a necked down (e.g., thinner) portion of the label holder 14 at which point the cover panel 24 may be designed to bend away from the front panel 18 of the shelf 12. In practice, the hinge 40 need not be a separate element or portion of the label holder 14, but could simply be the position whereat the cover panel 24 pivots away from the front panel 18 of the shelf 12 when a force is applied to the upper end 30 of the cover panel 24.

Once installed, the label 54 is trapped in place between the back surface 28 of the cover panel 24 and the front panel 18 of the shelf. Accordingly, the cover panel 24 will have at least a portion thereof that is transparent to enable the label to be viewed through the cover panel 24. The cover panel 24 can be made from a clear material such as a clear plastic, or can have portions thereof removed for viewing the label.

In use, the label holder 14 will be installed on the shelf 12 generally by sliding the clip member portion 36 beyond the return flange 20 until the return flange 20 clears the upwardly bent leading edge portion 50 of the upper jaw 44. In order to facilitate clearance of the clip member portion 36 to such position behind the front panel 18 of the shelf 12, the cover panel 24 can be bent outwardly in a similar manner to that shown in phantom in FIG. 1. Once the return flange 20 enters the space between the upper and lower jaws 44 and 46, the label holder 14 can then be shifted towards the front of the shelf 12 in order to seat the return flange 20 within the clip member portion 36, as illustrated in FIG. 1.

As the label holder 14 is brought leftward in FIG. 1, the cover panel 24 will engage the front panel 18 of the shelf 12 as illustrated. The label 54 can then be inserted or removed from between the cover panel 24 and the front panel 18 of the shelf 12 rotating the cover panel 24 away from the shelf 12 as shown. Typically, the cover panel 24 may be rotated approximately 40° or more away from the face of the front panel 18 of the shelf 12.

In order to facilitate grasping of the cover panel 24 for moving it between its respective positions, a rounded bead 58 is provided at the leading upper end 30 of the cover panel 24. This bead 58 allows a user to more readily grasp the upper end 30 of the cover panel 24 when it is engaged with the front panel 18 of the shelf 12 such as by inserting a fingernail behind the cover panel 24 and subsequently pulling the cover panel 24 away from the front panel 18 of the shelf 12 while then grasping the cover panel 24 between a forefinger and a thumb, for example. It will be appreciated that the bead 58 also provides a user a more stable grip on the cover panel 24 when the cover panel 24 is rotated away from the front panel 18 of the shelf 12 during installation of a label.

Once a label is installed between the cover panel 24 and the front panel 18 of the shelf 12, the cover panel 24 resiliently returns or is rotated back to the position shown in FIG. 1 whereat the cover panel 24 generally is configured to engage the label and/or the front panel 18 of the shelf 12 along a major portion of a length extending between the upper and lower ends 30 and 32 of the cover portion. In this regard, the hinge 40 may apply a biasing force to bias the cover panel 24 into engagement with the front panel 18 of the shelf 12. Such biasing force could serve to secure the label 54 between the cover panel 24 and the front panel 18 of the shelf 12 and also to automatically return the cover panel 24 to the label holding position shown in FIG. 1 from the position at which a label can be inserted between the cover panel 24 and the front panel 18 of the shelf 12 (shown in phantom in FIG. 1). In other words, the material of the cover panel 24 has memory and will return to its original position. To this end the label holder 14 can be extruded from a variety of known thermoplastics. In one embodiment, the material can be a clear rigid polyvinylchloride (RPVC). If desired, the label holder could be coextruded from different types of thermoplastics.

In one embodiment, the cover panel 24 is thinner than the clip portion 36 of the label holder 14. For example, the cover panel 24 can be about 0.020 inches in thickness while the thickness of the clip portion 36 can be about 0.030 inches. Employing a relatively thin cover panel 24 enables the cover panel to flex more readily in relation to the clip portion 36 of the label holder 14.

In the embodiment illustrated in FIGS. 1 and 2, the cover panel is generally planar and is adapted to closely engage the front panel 18 of the shelf 12 along a majority of its length between its upper and lower ends. Of course, other designs of the cover panel are possible.

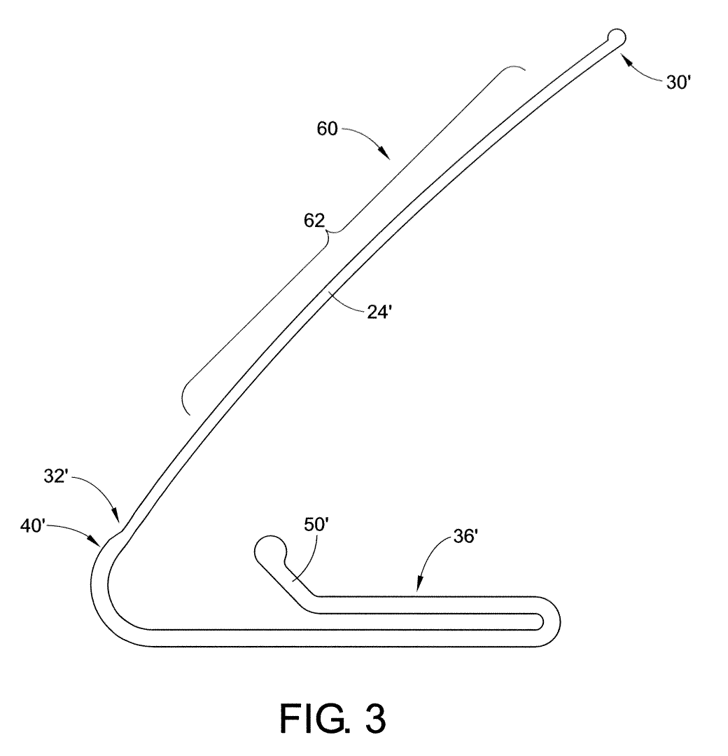

For example, turning to FIG. 3, another exemplary embodiment of a label holder is illustrated and identified generally by reference numeral 60. In this embodiment, like components are identified with like numerals with a primed (′) suffix and new components are identified by new numerals. The label holder is identical to the label holder 14 of FIGS. 1 and 2, except that the cover panel 24′ is slightly curved such that its upper and lower ends 30′ and 32′ are configured to closely engage the front panel of the shelf, while a mid-portion 62 of the cover panel 24′ between the upper end and the lower ends 30′ and 32′ is spaced apart from the front panel of the shelf as illustrated. Since the embodiment illustrated in FIG. 3 is otherwise similar to the embodiment of FIGS. 1 and 2 further details of the label holder 14 of FIG. 3 will not be repeated here. The embodiment of FIG. 3 may be particularly well suited for applications wherein a relatively thicker label will be used, or in applications where it would be desirable to more closely engage a label at its upper and lower edges rather than throughout its width.

In any of the embodiments, the back surface 28 of the cover panel 24 can be roughened or otherwise textured in order to increase friction between the cover panel 24 and the label. Alternatively, or in addition, nubs, teeth, or other protrusions could be provided on the back surface 28 of the cover panel 24 for engaging a label. Such protrusions can be used to focus pressure applied by the cover panel 24 resulting from the biasing force applied by the hinge. Similarly, it will be appreciated that the surfaces of the upper and lower jaws 44 and 46 can be provided with roughened portions thereof or with nubs, teeth, or other protrusions for enhancing grip between the clip member and the return flange 20.

In the illustrated embodiments, the cover panel 24 has a cross-sectional shape closely resembling the cross-sectional shape of a front face of a shelf 12 to which it is adapted to engage. For example, in the embodiment of FIGS. 1 and 2, the front panel 18 of the shelf 12 is substantially planar and correspondingly the cover panel 24 is substantially planar as well. It will be appreciated, however, that the front panel 18 can be configured in a variety of shapes to correspond to various shapes of front panels of shelves. For example, some front panels may be concave or convex, and the cover panel 24 could have a corresponding concave or convex shape as may be the case such that when installed the cover panel 24 may closely engage the front panel 18 of the shelf 12.

The exemplary embodiments of the present disclosure have been described with reference to the above detailed description. Obviously, modifications and alterations will occur to others upon a reading and understanding of the preceding detailed description. It is intended that the disclosure not be limited to the embodiments described. Rather, the present disclosure should be construed as including all such modifications and alterations as come within the scope of the appended claims or the equivalents thereof.

1. A retail display assembly comprising:
a shelf including a top panel, a front panel extending from the top panel, and a return flange extending from the front panel;
a label holder including a cover panel having a front surface, a back surface, an upper end and a lower end, a clip member extending rearwardly away from the cover panel, and a hinge connecting the lower end of the cover panel to the clip member;
wherein the label holder is selectively mountable to the shelf via the clip member; and
wherein when mounted to the shelf, the back surface of the cover panel and the front surface of the shelf are configured to trap an associated item therebetween.

2. A retail display as set forth in claim 1, wherein the associated item includes a label.

3. A retail display as set forth in claim 1, wherein at least a portion of the cover panel is transparent for viewing the associated item.

4. A retail display as set forth in claim 1, wherein the cover portion is moveable between a first position wherein the back surface is engaged with the front surface of the shelf, to a second position wherein the back surface is spaced apart from the front surface of the shelf.

5. A retail display as set forth in claim 4, wherein a distal edge of the cover portion opposite the hinge includes a bead for grasping by a user when moving the cover portion between the first and second positions.

6. A retail display as set forth in claim 1, wherein the hinge is adapted to bias the cover portion towards the front surface of the shelf.

7. A retail display as set forth in claim 1, wherein the cover panel is adapted to engage the front surface of the shelf along a major portion of a length of the cover panel extending between the upper and lower ends thereof.

8. A retail display as set forth in claim 1, wherein the clip member includes a pair of opposing jaws opening towards the hinge and configured to engage opposing sides of the return flange, the opposing jaws being biased towards each other to secure the label holder to the shelf.

9. A label holder comprising:
a cover panel having a front surface, a back surface, an upper end and a lower end;
a clip member extending rearwardly away from the cover panel near the lower end thereof; and
a hinge connecting the lower end of the cover panel to the clip member;
wherein the label holder is selectively mountable to an associated shelf via the clip member for trapping an associated label between the rear surface of the cover panel and a corresponding surface of the associated shelf.

10. A label holder as set forth in claim 9, wherein at least a portion of the cover panel is transparent for viewing the associated label.

11. A label holder as set forth in claim 9, wherein the cover panel is moveable between a first position for holding the associated label, and a second position for loading the associated label.

12. A label holder as set forth in claim 11, wherein the cover panel is resiliently biased towards the first position.

13. A label holder as set forth in claim 11, wherein a distal edge of the cover portion opposite the hinge includes a bead for grasping by a user when moving the cover panel between the first and second positions.

14. A label holder as set forth in claim 9, wherein the clip member includes a pair of opposing jaws opening towards the hinge and configured to engage opposing sides of a flange of the associated shelf, the opposing jaws being biased together to secure the label holder to the associated shelf.

15. A label holder as set forth in claim 9, wherein the hinge is adapted to bias the cover portion towards a front surface of shelf when installed thereon.

16. A label holder as set forth in claim 9, wherein a thickness of the cover panel is less than a thickness of the clip portion.

17. A label holder as set forth in claim 16, wherein the thickness of the cover panel is generally constant from the upper end to the lower end.
